(19) United States
(12) Patent Application Publication
(10) Pub. No.: US 2025/0201212 A1
(43) Pub. Date: Jun. 19, 2025

(54) Shield Harp

(71) Applicant: Christopher Richard Rawson, Plattsburgh, NY (US)

(72) Inventor: Christopher Richard Rawson, Plattsburgh, NY (US)

(21) Appl. No.: 18/542,679

(22) Filed: Dec. 17, 2023

(51) Int. Cl. G10D 3/10; G10D 1/04; G10D 3/02; G10D 3/12

(52) U.S. Cl. CPC G10D 3/10; G10D 1/04; G10D 3/02; G10D 3/12

(57) ABSTRACT

One aspect of this invention relates to a harp with a novel chromatic string arrangement. Another aspect of this invention relates to a frame structure to support said string arrangement which is shield shaped.

### FIELD OF THE INVENTION

This invention generally relates to harp style musical instruments having a rigid frame supporting an array of tensioned strings or wires which vibrate when plucked or strummed.

### BACKGROUND OF THE INVENTION

Most extant harps are strung in a repeating diatonic scale with seven strings per octave the same as playing only white keys or naturals on a piano: c, d, e, f, g, a, b, c . . . . However most extant music is written with at least one of five chromatic notes not included in a diatonic scale and represented as the black keys or sharps on a piano: c♯, d♯, f♯, g♯, a♯. The most common solution to this problem is to temporarily alter the speaking length of certain strings via a mechanism attached to the neck of the harp which comes in contact with the strings when engaged. Pedal harps use a set of rotating disks mounted near the top of each string attached to an array of seven, foot operated pedals. Pedal harps are generally very large, heavy, and expensive, therefore not a practical option for beginners, novices, or those with disabilities. Lever harps use a plurality of hand operated levers attached to the neck wherein a lever is mounted near the top of each string just below the bridge pins. To use a lever harp, a harpist sets a series of levers into the up position to sharpen the pitch of certain strings before playing a song that requires sharps. There are many songs however that require the harpist to change lever positions while playing because both sharps and naturals using the same string are needed. This is somewhat difficult because it requires one hand and one eye momentarily away from the playing position to operate a lever. Additionally, neither lever harps nor pedal harps can play natural notes and sharp notes on the same string simultaneously.

A double strung harp is constructed with two identical rows of strings running parallel to each other, some of which acting as sharps, however many harpists find this arrangement difficult to play because from the sight line of the player with the harp leaning on their right shoulder it is difficult to focus the eyes on just one row of strings at a time. A cross strung harp has two rows of strings mounted perpendicular to each other so that the two rows of strings cross in between each other in an x pattern running from top to bottom. In a cross strung harp, one row of strings is all naturals and the other row of strings is all sharps, allowing any note to be played on either side of the harp with either hand, however like the double strung harp there is a line of sight disadvantage, as well as the need to change hand angle frequently. The sharp strings on a cross strung harp are not evenly spaced and this affects playing smoothness on glissandos. Both double strung and cross strung harps struggle with resonance because the sound box that anchors the strings must be more rigid to handle the combined tension of two rows of strings anchored to a single panel of wood.

Chromatic strung harps have all twelve chromatic notes in an octave in order on a single row of strings. This however makes the instrument more difficult to play for several reasons, first because it adds an extra five strings in an octave making it difficult to reach an octave with one hand, second it makes clean sounding glissandos in any key signature impossible because too many notes are played at once when sliding a finger across a section of strings. Third it requires a different technique than a standard harp to play a diatonic scale. Autoharps are tuned this way with a chromatic row of strings but they require rows of dampers mounted on wooden bars to mute unwanted strings when strummed in a specific scale, and autoharps can only be played from one side.

Most extant harp frames are built with a column on the front side, a neck on the top, and one string anchoring panel or soundbox on the back side. The three members form a triangular shaped profile. The longest strings are at the front, and the shortest strings are at the back.

### BRIEF SUMMARY OF THE INVENTION

The present invention is a harp string and frame arrangement wherein evenly spaced strings are arranged by length into two concurrent arrays: a first array of strings increasing in length and decreasing in vibrating frequency progressively from back to front, and a second array running in line with the first array decreasing in length and increasing in vibrating frequency progressively from back to front. This arrangement allows a harpist to play diatonic or pentatonic glissandos, as well as play any note in a chromatic scale with either hand without the absolute necessity of using string sharping mechanisms, or changing hand angle. Because the strings are in line with each other there is no visual confusion. This style of harp has a shield shaped profile and so the inventor refers to it as a shield harp. The shield harp allows beginning and advanced harp players an affordable, portable, and intuitive instrument that can easily play any note desired in a chromatic scale. In one embodiment, the back array of strings is arranged in a diatonic musical scale, and the front array of strings is arranged in a pentatonic musical scale. The two scales when played alternately by string length play a non consecutive chromatic scale. The shield harp is typically constructed having a heater battle shield shaped profile with a curved neck and a V shaped hollow sound box wherein the neck is connected to the soundbox at both ends without a column being needed in between. The sound box is constructed with two string anchoring panels which are mounted at perpendicular angles to each other in between two side panels. The string anchoring panels do not directly touch each other, having a gap in between them at their base so they may vibrate in opposing directions simultaneously without impeding each other. The shield harp is scalable to different ranges of notes and can be constructed with the two arrays of strings mounted either in line with each other, or offset from each other, or curved for improved ergonomics. It can also be constructed with a solid body and electric pick ups for amplification if desired.

### BRIEF DESCRIPTION OF THE DRAWING

FIG. 1 shows the shield harp as seen from the right side, with dotted lines representing the portion of the strings and anchor panels which are obscured by the neck and side panels.

### DETAILED DESCRIPTION

A harp having two arrays of strings 1,2, that are mounted in line with each other held in place by a frame having a shield shaped profile. The inventor refers to this invention as a shield harp, though it could also be shaped to resemble a kite with less curved edges.

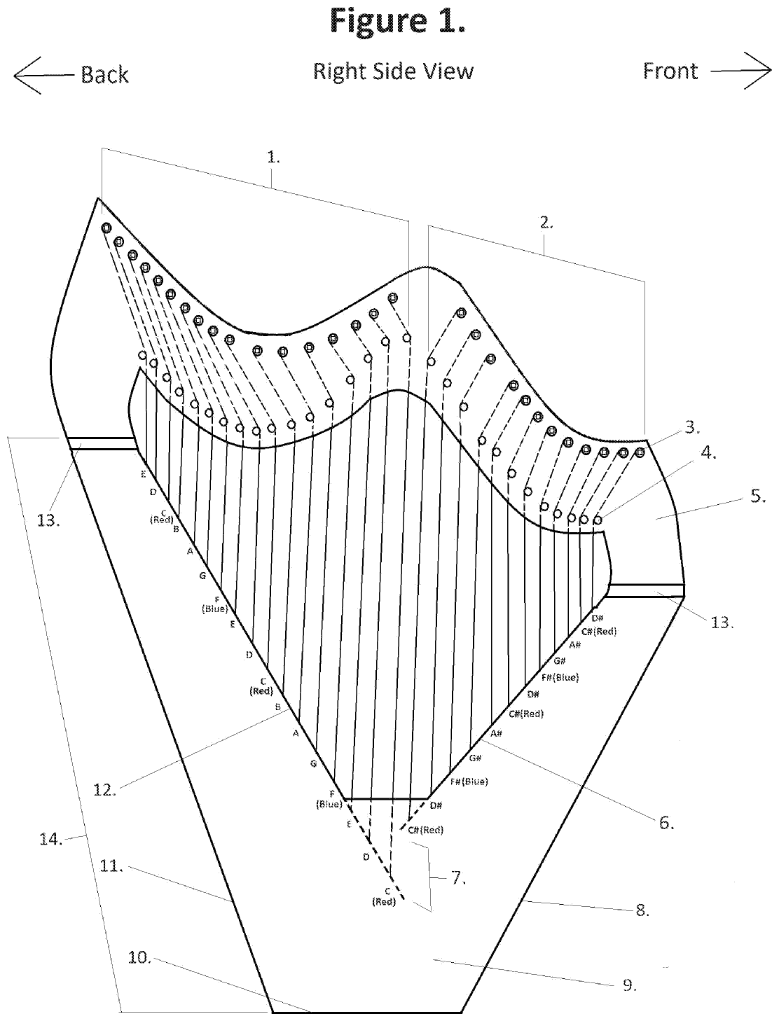

The shield harp is constructed with the front array of strings 2 in reverse order by vibrating frequency to the back array of strings 1 so that the longest and lowest pitch strings of both arrays 1,2, are near the center of the harp, and the shortest and highest pitch strings are near the front and back. FIG. 1. shows a twenty-nine string embodiment with strings arranged as follows from back to front: e, d, c, b, a, g, f, e, d, c, b, a, g, f, e, d, c, c♯, d♯, f♯, g♯, a♯, c♯, d♯, f♯, g♯, a♯, c♯, d♯. Testing of prototypes has shown that beginners can learn to play any song intuitively on this design without professional instruction.

One embodiment of this invention which has been built has thirty-seven strings, is approximately 8″ wide, 38″ tall and 30″ long with all the strings spaced approximately 14 mm apart. The two string anchoring panels 6&12, the front panel 8, bottom panel 10, and the back panel 11 are made of cut sheets of ¼″ plywood which are mounted to the side panels 9 made of ½″ thick plywood. Top panels 13 are made from ½″ thick plywood and mounted across the tops of side panels 9. All the panels permanently mounted together 6,8,9,10,11,12,13 form a V shaped resonant hollow soundbox 14. The string anchoring panels 6&12 are mounted with a vertical gap 7 in between them so that they can vibrate perpendicular to each other without impeding each other. The neck 5 is made of 1.5″ thick plywood and is permanently mounted at both ends to the soundbox 14. The neck 5 has holes drilled through it to accept tuning pins 3 and bridge pins 4. The tuning pins 3 are inserted through the neck 5 so that the strings are attached on the left side of neck 5 and a tuning lever is attached on the right side of neck 5. Bridge pins 4 are pressed tightly into the drilled holes. Nylon strings are made having a knot at the bottom end and are inserted through string sized holes drilled in the center of anchor panels 6&12 of the soundbox 14. Strings for the notes c and c♯ are tinted red. Strings for the notes f and f♯ are tinted blue. For the back array of strings 1, after passing through the rear anchor panel 12, the strings are deflected forward by the bridge pins 4 before being attached to the back side of the tuning pins 3. For the front array of strings 2 comprising a pentatonic scale, after passing through the front anchor panel 6, the strings are deflected backward by the bridge pins 4 before being attached to the back side of the tuning pins 3. The tuning pins 3 for both arrays of strings 1&2 are turned clockwise using a tuning key or lever to tighten the strings to the correct tension. To play the shield harp, a harp player sits or stands behind the back side with their right shoulder centered on the frame, then reaches forward with either hand to pluck strings from either side as desired.

One alternate method of constructing this harp is using guitar type tuning machines instead of tuning pins. The strings are threaded up through the center of the neck instead of up the side. Another alternate method of construction is to use electronic pickups to amplify the sound instead of using a hollow sound box, wherein the lower section of the harp is solid instead of hollow, and has electric pickups mounted near the string anchor points. Said embodiment would be approximately 4″ wide instead of 8″, but still maintain the same heater shield shaped profile, and be played in the same manner.

The shield harp can vary greatly in overall size depending on the number of octaves desired. Prototypes of this harp have been designed and built by the inventor with two octave, three octave, and four octave ranges having twenty-five strings, thirty-seven strings, and forty-nine strings respectively. The two arrays of strings 1&2 can be installed in an unbroken line with each other, or they can be slightly offset or curved for improved ergonomics without deviating from the general frame profile or string arrangement.

### PRIOR ART

### Keyed Harp

U.S. Pat. No. 16,489A
Kuhn 1857

### Guitar Harp

U.S. Pat. No. 612,005A
Maggio 1898

### Autoharp

U.S. Pat. No. 634,142A
Heymann 1899

### Chromatic Harp

U.S. Pat. No. 707,041A
Weigel 1900

### Double Strung Harp

U.S. Pat. No. 666,016A
Lehman 1901

### Double Strung Harp Side Strung

U.S. Pat. No. 790,029A
Childs 1904

### Center Strung Harp

U.S. Pat. No. 812,209A
Kolby 1905

### Pedal Harp

U.S. Pat. No. 786,275A
Ekman 1905

### Harp

U.S. Pat. No. 796,788A
FC Young 1905

### Musical Instrument

U.S. Pat. No. 892,908A
Sorglechner 1906
   Harp with Pedal Chromatic
U.S. Pat. No. 1,039,303A
Lyon 1909

### Harp Sharping Blades

U.S. Pat. No. 1,105,879A
Clark 1911

### Harp

U.S. Pat. No. 1,049,176A
Varian 1912

### Guitar

U.S. Pat. No. 1,183,369A
Gardie 1915

### Hand Knob Operated Pedal Harp

U.S. Pat. No. 1,406,347A
Clark 1919

### Harp Fork

U.S. Pat. No. 1,563,141A
Aslanian 1924

### Heart Harp

U.S. Pat. No. 1,799,696A
Miller 1931

### Chromatic Harp

U.S. Pat. No. 2,137,160A
Franklin 1937

### Electronic Key Change Harp

U.S. Pat. No. 2,812,681A
Carron 1953

### Cross Strung Harp

DE1924225U
Sorokin 1965
U.S. Pat. No. 3,739,680A

### Harp Construction

Christiansen 1971

### Heart Harp

USD274627S
Ledford 1981

### Electronic Harp

U.S. Pat. No. 4,744,280A
Garritano 1986

### Harp Improved Nut

U.S. Pat. No. 4,696,217A
MacWilliams 1986

### Harp w Composite Material

U.S. Pat. No. 4,919,024A
Budin 1987

### Harp Carrier

U.S. Pat. No. 4,781,391A
Hartwig 1987

### Tetrahedral Harp

GB2243014A
Murray 1991

### Sharping Mechanism

U.S. Pat. No. 5,140,883A
Fay 1991

### Semitone Mechanism for Harps

AT403330B
Kurt 1996

### Pedal Sharping Apparatus

U.S. Pat. No. 6,008,439A
Kovac 1997

### Hand Manipulated Sharping Lever

U.S. Pat. No. 5,796,020A
Truitt 1997

### Blade Sharping Device

U.S. Pat. No. 6,080,921A
Cunningham 1998

### In Line Chromatic Harp

U.S. Pat. No. 7,015,387B2
Chen 2004
   Stringed Musical Instrument with Multiple Bridge-Soundboard Units
US20060150797A1
Gaffga 2005

### Harp Sound Box Construction

U.S. Pat. No. 7,498,495B1
Mooers 2005

### Electric Harp

U.S. Pat. No. 7,534,954B1
Cassista 2006

### Chord Bar Unit

JP2007279647A
Harada 2006
   Stringed Musical Instrument Derived from Harps
US20060011048A1
Kostner 2006
U.S. Pat. No. 7,674,962B2
   Harp with Exposed Soundboard
Ramirez 2007
CA2784854C

### Electric Harp

Moon 2010

### Improved Harp Sound Chest

EP2583273B1
Belmondo 2010
   Harp with Exposed Soundboard and Separate Bridges and Method of Altering the Pitch of the Harp Strings
U.S. Pat. No. 7,674,962B2
Ramirez 2010

### Stringed Musical Instrument

U.S. Pat. No. 7,939,735B2
Ahn et al 2011

### Pedal Harp

AU2017201260A1
Jones 2011

### Concert Harp Cart

DE102013000782A1
2013

### Carbon Fiber Pedal Harp

US20140366704A1
Woodworth 2013

### Harp Semitone Key

CN214541530U
Chinese 2021

### Chromatic Scale Harp

KR20230023414A
Korean 2021

1. A harp comprising a frame, a first array of strings arranged by length into a first musical scale spanning at least one octave, and a second array of strings arranged by length in a second musical scale spanning at least one octave, wherein said first array of strings becomes progressively longer from back to front, and said second array of strings becomes progressively shorter from back to front.

2. A harp frame comprising a neck and a sound box, wherein said neck is directly connected to said sound box at both ends, wherein said sound box is v shaped.

3. A harp as recited in claim 1 having a heater battle shield shaped profile.

4. A harp as recited in claim 1 wherein said first array of strings comprises a diatonic scale, and said second array of strings comprises a pentatonic scale.

5. A harp as recited in claim 1 wherein all C & C♯ strings are tinted a first color and all F & F♯ strings are tinted a second color.

6. A harp as recited in claim 1 wherein all C strings are tinted a first color, all F strings are tinted a second color, all C♯ strings are tinted a third color, and all F♯ strings are tinted a fourth color.

7. A harp as recited in claim 1 wherein said first array of strings comprises a diatonic scale and said second array of strings also comprises a diatonic scale.

8. A sound box as recited in claim 2 comprising a first string anchoring panel sloped downward from back to front, a second string anchoring panel sloped upward from back to front, and two vertical side panels, wherein both string anchoring panels are affixed on their left and right sides to said side panels, wherein there is a gap maintained between said first and second string anchoring panels.

9. A harp as recited in claim 1 wherein said arrays of strings are in line with each other on the same plane.

10. A harp as recited in claim 1 wherein said string arrays are offset from each other.

11. A harp as recited in claim 1 wherein said string arrays are curved.
